(19) United States
(12) Patent Application Publication
(10) Pub. No.: US 2018/0030299 A1
(43) Pub. Date: Feb. 1, 2018

(54) AQUEOUS INK SET, INK CARTRIDGE SET, INKJET RECORDING METHOD, AND INKJET RECORDING APPARATUS

(71) Applicant: FUJI XEROX CO., LTD., Tokyo (JP)

(72) Inventor: Yoshiro YAMASHITA, Kanagawa (JP)

(73) Assignee: FUJI XEROX CO., LTD., Tokyo (JP)

(21) Appl. No.: 15/442,808

(22) Filed: Feb. 27, 2017

(30) Foreign Application Priority Data
Jul. 28, 2016 (JP) 2016-148924

(51) Int. Cl. C09D 11/40; B41J 2/01; C09D 11/033; C09D 11/322; C09D 11/037

(52) U.S. Cl. CPC C09D 11/40; C09D 11/322; C09D 11/037; C09D 11/033; B41J 2/01

(57) ABSTRACT

An aqueous ink set includes a first aqueous ink containing water and a colorant, and a second aqueous ink containing water and a colorant, having a hue in the same category as in the first aqueous ink, and having a lower drying rate than the first aqueous ink.

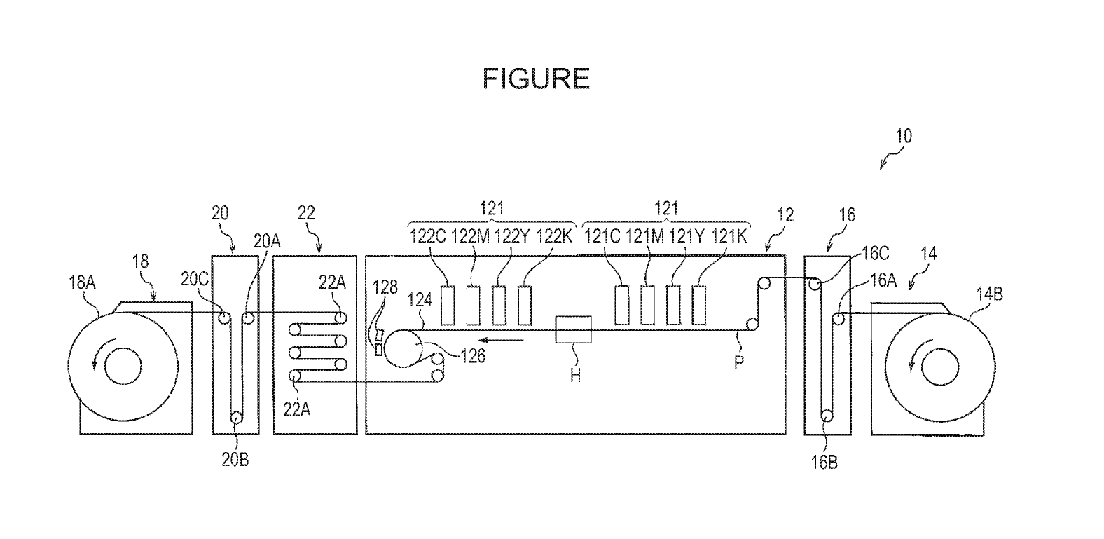

### CROSS-REFERENCE TO RELATED APPLICATIONS

This application is based on and claims priority under 35 USC 119 from Japanese Patent Application No. 2016-148924 filed Jul. 28, 2016.

### BACKGROUND

### (i) Technical Field

The present invention relates to an aqueous ink set, an ink cartridge set, an inkjet recording method, and an inkjet recording apparatus.

### (ii) Related Art

The inkjet printing technology is easily applicable to printing for a larger printing width at a higher printing speed, and hence has considerably increased its share in the printing field.

In particular, there has been an increasing demand for recording on recording media having a low liquid-permeation rate (low-permeability recording media and impermeable recording media) such as coat paper for printing, with a water-containing inkjet ink (water-based inkjet ink).

### SUMMARY

According to an aspect of the invention, there is provided an aqueous ink set including: a first aqueous ink containing water and a colorant; and a second aqueous ink containing water and a colorant, having a hue in the same category as in the first aqueous ink, and having a lower drying rate than the first aqueous ink.

### BRIEF DESCRIPTION OF THE DRAWING

An exemplary embodiment of the present invention will be described in detail based on the following figure, wherein:

FIGURE is a schematic view illustrating an example of the configuration of an inkjet recording apparatus according to an exemplary embodiment.

### DETAILED DESCRIPTION

Hereinafter, an exemplary embodiment will be described. Incidentally, “parts by mass” and “mass %” herein respectively have the same meanings as “parts by weight” and “weight %”.

In the following description, formation of an image by ejecting aqueous inks onto (a target region of) a recording medium is sometimes referred to as “image formation” or “form an image”; and a process including ejecting aqueous inks onto a recording medium and drying and fixing of the ejected aqueous inks is sometimes referred to as “recording”, “image recording”, or “record an image”.

### <Aqueous Ink Set>

An aqueous ink set (sometimes simply referred to as the “ink set”) according to the exemplary embodiment includes a first aqueous ink, and a second aqueous ink having a hue in the same category as in the first aqueous ink, and having a lower drying rate than the first aqueous ink.

The aqueous ink set according to the exemplary embodiment is suitably usable as an aqueous ink set for inkjet recording.

Because of the above-described features, the aqueous ink set according to the exemplary embodiment enables suppression of occurrence of streak unevenness in images to be formed. This is achieved by the following probable mechanism.

For image formation on recording media such as printing paper, there has been a recent trend toward printing on demand. In order to perform printing on demand, inkjet printing, which does not require plates, is better in terms of delivery time and cost than plate-requiring printing methods.

Aqueous ink has gained recent attention because its raw material is safer and aqueous ink is environmentally safer.

However, when an aqueous inkjet printer is used for image formation, before ink dries, ink droplets come into contact with each other and hence are displaced. This often results in image defects such as streak unevenness.

In particular, such image defects occur when a recording medium that is less permeable to ink is used, and an existing ink set and an existing inkjet recording method are employed. Specifically, after ink droplets are ejected onto the recording medium and before the ink droplets dry or permeate into the recording medium, large amounts of the ink droplets come into contact with each other on the recording medium. This results in occurrence of an interaction between ink droplets referred to as inter-droplet interference. Thus, ink droplets are probably made to be displaced from the intended positions for image formation, which results in occurrence of image defects such as streak unevenness.

In order to address such image defects, during image formation, each pixel is formed with at least two aqueous inks. This is achieved by using at least two aqueous inks that have hues in the same category and differ in the drying rate. Of such two aqueous inks, the aqueous ink having a higher drying rate is first ejected and, from this aqueous ink, the solvent such as water is at least partially removed by, for example, permeation into the recording medium, air drying, or a drying unit. Over the resultant aqueous ink, the other aqueous ink having a lower drying rate is further ejected to form each pixel. This achieves a reduction in the amount of ink droplets adjacent to each other in liquid form on the recording medium, which results in suppression of inter-droplet interference between ink droplets. Therefore, occurrence of streak unevenness is reduced and the image quality is improved.

Hereinafter, the aqueous ink set according to the exemplary embodiment will be described further in detail.

In the exemplary embodiment, inks having “hues in the same category” mean as follows: for example, color inks in the cyan category individually have, in their visible spectra, absorbance peaks in the wavelength range of 600 nm or more and 720 nm or less; color inks in the magenta category individually have, in their visible spectra, absorbance peaks in the wavelength range of 500 nm or more and 600 nm or less; and color inks in the yellow category individually have, in their visible spectra, absorbance peaks in the wavelength range of 380 nm or more and 500 nm or less.

In the case of black inks, inks that exhibit absorption, in their visible spectra, over the whole wavelength region of 400 nm or more and 720 nm or less, are defined as having hues in the same category.

The drying rates of aqueous inks in the aqueous ink set according to the exemplary embodiment are each measured in the following manner.

1) About 10 mg of such an ink is weighed and dropped onto a glass plate. The weight of the resultant glass plate is measured.

2) The glass plate having the dropped ink thereon is heated on a hot plate at 40° C.

3) After the heating is carried out for 20 minutes, the weight of the glass plate is measured. The difference between this measured weight and the initial weight is calculated, and a change in the weight per unit time is determined as the drying rate.

The aqueous ink set according to the exemplary embodiment can be made such that, from the viewpoint of suppression of occurrence of streak unevenness in images to be formed, image density, and head clogging resistance, the colorant content of the second aqueous ink is higher than the colorant content of the first aqueous ink.

The second aqueous ink can also have a high drying rate from the viewpoint of image formation speed. In consideration of resistance to inkjet-head clogging caused by evaporation (drying) of ink at the nozzle end portions, the second aqueous ink, which has a composition providing a lower drying rate than the first aqueous ink, can be made to have a higher colorant content than the first aqueous ink.

From the viewpoint of suppression of occurrence of streak unevenness in images to be formed, image density, and head clogging resistance, the ratio of the colorant content C^{1W} of the first aqueous ink to the colorant content C^{2W} of the second aqueous ink is preferably 0.3≦C^{1W}/C^{2W}<1, more preferably 0.4≦C^{1W}/C^{2W}≦0.95, particularly preferably 0.5≦C^{1W}/C^{W}≦0.9.

The aqueous ink set according to the exemplary embodiment can be made such that, from the viewpoint of suppression of occurrence of streak unevenness in images to be formed, the first aqueous ink has a content of 80 mass % or more or about 80 mass % or more of a solvent containing the water and having a boiling point of less than 150° C., and the content of a solvent containing the water and having a boiling point of less than 150° C. in the second aqueous ink is less than the content of the solvent containing the water and having a boiling point of less than 150° C. in the first aqueous ink.

The aqueous ink set according to the exemplary embodiment can be made such that, from the viewpoint of drying rate and suppression of occurrence of streak unevenness in images to be formed, the content of the solvent containing the water and having a boiling point of less than 150° C. in the first aqueous ink is preferably 75 mass % or more, more preferably 80 mass % or more and 90 mass % or less, particularly preferably 80 mass % or more and 87 mass % or less.

Furthermore, the aqueous ink set according to the exemplary embodiment can be made such that, from the viewpoint of drying rate, head clogging resistance, and suppression of occurrence of streak unevenness in images to be formed, the content of the solvent containing the water and a boiling point of less than 150° C. in the second aqueous ink is preferably 50 mass % or more and less than 90 mass %, more preferably 60 mass % or more and less than 85 mass %, particularly preferably 65 mass % or more and 80 mass % or less.

The solvent having a boiling point of less than 150° C. in the first aqueous ink preferably has a water content of 90 mass % or more, more preferably a water content of 95 mass % or more, particularly preferably the solvent having a boiling point of less than 150° C. in the first aqueous ink is water.

The solvent having a boiling point of less than 150° C. in the second aqueous ink preferably has a water content of 90 mass % or more, more preferably a water content of 95 mass % or more, particularly preferably the solvent having a boiling point of less than 150° C. in the second aqueous ink is water.

The aqueous ink set according to the exemplary embodiment may include one set of the first aqueous ink and the second aqueous ink that have hues in the same category, or may include two or more sets of the first aqueous ink and the second aqueous ink that have hues in the same category.

Examples of the hues include cyan, magenta, yellow, black, white, green, orange, and violet.

In particular, the aqueous ink set according to the exemplary embodiment preferably includes, from the viewpoint of facilitation of formation of full-color images, the first aqueous inks that are cyan, magenta, and yellow inks, and the second aqueous inks that are cyan, magenta, and yellow inks; more preferably includes the first aqueous inks that are cyan, magenta, yellow, and black inks, and the second aqueous inks that are cyan, magenta, yellow, and black inks.

The aqueous ink set according to the exemplary embodiment may contain, in addition to the first aqueous ink and the second aqueous ink, a third aqueous ink that has a hue in the same category as in the first aqueous ink and the second aqueous ink, and that has a lower drying rate than the second aqueous ink, and also an (n+1)-th aqueous ink that has a hue in the same category as in the first to the n-th aqueous inks, and that has a lower drying rate than the n-th aqueous ink where n represents an integer of 3 or more.

From the viewpoint of the simplicity and cost of the inkjet recording apparatus, the aqueous ink set according to the exemplary embodiment preferably includes, as aqueous inks that have hues in the same category, only the first aqueous ink, the second aqueous ink, and the third aqueous ink, more preferably includes, as aqueous inks having hues in the same category, only the first aqueous ink and the second aqueous ink.

Hereinafter, such an aqueous ink used in the exemplary embodiment will be described further in detail.

The aqueous ink used in the exemplary embodiment preferably contains a colorant, and a solvent containing water and an aqueous organic solvent; more preferably contains a colorant, polymer particles, and a solvent containing water and an aqueous organic solvent; particularly preferably contains a colorant, polymer particles, a polymer dispersing agent, a surfactant, and a solvent containing water and an aqueous organic solvent.

### Colorant

The colorant will be first described.

The colorant can be selected in accordance with the target hue of the aqueous ink. Specifically, the colorant may be a pigment. Examples of the pigment include organic pigments and inorganic pigments.

Non-limiting specific examples of a cyan pigment include C.I. Pigment Blue-1, -2, -3, -15, -15:1, -15:2, -15:3, -15:4, -16, -22, and -60.

Non-limiting specific examples of a magenta pigment include C.I. Pigment Red-5, -7, -12, -48, -48:1, -57, -112, -122, -123, -146, -168, -177, -184, and -202, and C.I. Pigment Violet-19.

Non-limiting specific examples of a yellow pigment include C.I. Pigment Yellow-1, -2, -3, -12, -13, -14, -16, -17, -73, -74, -75, -83, -93, -95, -97, -98, -114, -128, -129, -138, -151, -154, -155, -180, and -185.

Non-limiting specific examples of a black pigment include Raven 7000, Raven 5750, Raven 5250, Raven 5000 ULTRAII, Raven 3500, Raven 2000, Raven 1500, Raven 1250, Raven 1200, Raven 1190 ULTRAII, Raven 1170, Raven 1255, Raven 1080, Raven 1060 (all manufactured by Columbian Carbon Company); Regal 400R, Regal 330R, Regal 660R, Mogul L, Black Pearls L, Monarch 700, Monarch 800, Monarch 880, Monarch 900, Monarch 1000, Monarch 1100, Monarch 1300, Monarch 1400 (all manufactured by Cabot Corporation); Color Black FW1, Color Black FW2, Color Black FW2V, Color Black 18, Color Black FW200, Color Black 5150, Color Black 5160, Color Black 5170, Printex 35, Printex U, Printex V, Printex 140U, Printex 140V, Special Black 6, Special Black 5, Special Black 4A, Special Black 4 (all manufactured by Orion Engineered Carbons S.A.); No. 25, No. 33, No. 40, No. 47, No. 52, No. 900, No. 2300, MCF-88, MA600, MA7, MA8, and MA100 (all manufactured by Mitsubishi Chemical Corporation).

When a pigment is used as the colorant, a pigment dispersing agent can be additionally used. Examples of the pigment dispersing agent include polymer dispersing agents and surfactants described later such as anionic surfactants, cationic surfactants, amphoteric surfactants, and nonionic surfactants.

Such a polymer dispersing agent can be a polymer having a hydrophilic structure portion and a hydrophobic structure portion. Examples of the polymer having a hydrophilic structure portion and a hydrophobic structure portion include condensation polymers and addition polymers. Examples of the condensation polymers include known polyester dispersing agents. Examples of the addition polymers include addition polymers synthesized from monomers having α,β-ethylenically unsaturated groups. A desired polymer dispersing agent can be obtained by copolymerization of a monomer having a hydrophilic group and an α,β-ethylenically unsaturated group and a monomer having a hydrophobic group and an α,β-ethylenically unsaturated group. Alternatively, another polymer dispersing agent may be used that is a homopolymer of a monomer having a hydrophilic group and an α,β-ethylenically unsaturated group.

Examples of the monomer having a hydrophilic group and an α,β-ethylenically unsaturated group include monomers having a carboxyl group, a sulfonic group, a hydroxyl group, or a phosphate group. Examples of the monomers include acrylic acid, methacrylic acid, crotonic acid, itaconic acid, itaconic monoesters, maleic acid, maleic monoesters, fumaric acid, fumaric monoesters, vinylsulfonic acid, styrenesulfonic acid, sulfonated vinylnaphthalene, vinyl alcohol, acrylamide, methacryloxyethylphosphate, bismethacryloxyethylphosphate, methacryloxyethylphenyl acid phosphate, ethylene glycol dimethacrylate, and diethylene glycol dimethacrylate.

Examples of the monomer having a hydrophobic group and an α,β-ethylenically unsaturated group include styrene derivatives such as styrene, α-methylstyrene, and vinyltoluene; vinylcyclohexane, vinylnaphthalene, vinylnaphthalene derivatives, acrylic acid alkyl esters, methacrylic acid alkyl esters, methacrylic acid phenyl esters, methacrylic acid cycloalkyl esters, crotonic acid alkyl esters, itaconic acid dialkyl esters, and maleic acid dialkyl esters.

Preferred examples of copolymers as the polymer dispersing agent include styrene-styrenesulfonic acid copolymers, styrene-maleic acid copolymers, styrene-methacrylic acid copolymers, styrene-acrylic acid copolymers, vinylnaphthalene-maleic acid copolymers, vinylnaphthalene-methacrylic acid copolymers, vinylnaphthalene-acrylic acid copolymers, acrylic acid alkyl ester-acrylic acid copolymers, methacrylic acid alkyl ester-methacrylic acid copolymers, styrene-methacrylic acid alkyl ester-methacrylic acid copolymers, styrene-acrylic acid alkyl ester-acrylic acid copolymers, styrene-methacrylic acid phenyl ester-methacrylic acid copolymers, styrene-methacrylic acid cyclohexyl ester-methacrylic acid copolymers, and salts of the foregoing. These polymers may be copolymerized with a monomer having a polyoxyethylene group and a hydroxyl group.

In particular, the polymer dispersing agent is preferably selected from the group consisting of styrene-acrylic acid copolymers and styrene-acrylic acid salt copolymers, more preferably styrene-acrylic acid salt copolymers, particularly preferably styrene-alkali metal acrylate copolymers.

The polymer dispersing agent preferably has a weight-average molecular weight of 2,000 or more and 50,000 or less. Incidentally, unless otherwise specified, the weight-average molecular weights described in the exemplary embodiment are values determined by gel permeation chromatography (GPC) and conversion relative to polystyrene standards.

Such polymer dispersing agents may be used alone or in combination of two or more thereof. The polymer dispersing agent content, which considerably varies depending on the pigment and cannot be generalized, is preferably 0.1 mass % or more and 100 mass % or less relative to the pigment.

Examples of the pigment also include a pigment that is self-dispersible in water (hereafter sometimes referred to as the self-dispersible pigment).

The self-dispersible pigment denotes a pigment having a pigment-surface group that makes the pigment be soluble in water, so that the pigment is dispersible in water even in the absence of a polymer dispersing agent. The self-dispersible pigment is obtained by, for example, subjecting a pigment to a surface modification treatment such as an acid-base treatment, a coupling-agent treatment, a polymer graft treatment, a plasma treatment, or an oxidation/reduction treatment.

Examples of the self-dispersible pigment include, in addition to pigments obtained by subjecting the above-described pigments to surface modification treatment, commercially available products including self-dispersing pigments manufactured by Cabot Corporation such as Cab-o-jet-200, Cab-o-jet-300, Cab-o-jet-400, IJX-157, IJX-253, IJX-266, IJX-273, IJX-444, IJX-55, Cab-o-jet-250C, Cab-o-jet-260M, Cab-o-jet-265M, Cab-o-jet-270Y, Cab-o-jet-450C, Cab-o-jet-465M, Cab-o-jet-470Y, and Cab-o-jet-480M, and self-dispersing pigments manufactured by ORIENT CHEMICAL INDUSTRIES CO., LTD. such as Microjet Black CW-1 and CW-2.

The self-dispersible pigment is preferably a pigment at least having a surface functional group that is sulfonic acid, a sulfonic acid salt, a carboxylic acid, or a carboxylic acid salt, more preferably a pigment at least having a surface functional group that is a carboxylic acid or a carboxylic acid salt.

Examples of the pigment also include a resin-covered pigment. This is called a microcapsule pigment and there are commercially available microcapsule pigments such as those manufactured by DIC Corporation and those manufactured by TOYO INK CO., LTD. However, the microcapsule pigment is not limited to such commercially available microcapsule pigments, and a microcapsule pigment produced in accordance with the purpose may be used.

Examples of the pigment also include a resin-type dispersible pigment in which a polymer is physically adsorbed onto or chemically bonded to a pigment.

Examples of the pigment include, in addition to black pigments and three primary color (cyan, magenta, and yellow) pigments, extra-color pigments having a color such as red, green, blue, brown, or white; metallic-luster pigments having a color such as gold or silver; and colorless or light-colored pigments such as body pigments and plastic pigments.

Examples of the pigment also include particles in which a dye or a pigment is fixed on the surfaces of cores such as silica or alumina cores or polymer beads; insolubilized lake dyes; colored emulsions; and colored latexes.

Examples of the colorant include, in addition to pigments, dyes such as hydrophilic anionic dyes, direct dyes, cationic dyes, reactive dyes, polymer dyes, and oil-soluble dyes; dye-colored wax powders, resin powders, or emulsions; fluorescent dyes; and fluorescent pigments.

The colorant may have a volume-average particle size of, for example, 10 nm or more and 1,000 nm or less.

The volume-average particle size of the colorant denotes the particle size of the colorant itself or, when an additive such as a dispersing agent adheres to the colorant, the particle size of the additive-adhering colorant.

The volume-average particle size is measured with a Microtrac UPA particle size analyzer UPA-UT151 (manufactured by Microtrac, Inc.). Specifically, the aqueous ink is measured after being diluted 1,000-fold and charged into a measurement cell. During the measurement, the value employed to be input as the viscosity is the viscosity of the diluted aqueous ink, and the value employed to be input as the particle refractive index is the refractive index of the colorant.

The colorant content (concentration) relative to the aqueous ink is, for example, preferably 1 mass % or more and 25 mass % or less, more preferably 2 mass % or more and 20 mass % or less.

### Polymer Particles

The polymer particles will be described below.

The aqueous ink used in the exemplary embodiment can contain polymer particles.

The polymer particles are a component that enhances the image fixability of the aqueous ink on a recording medium.

Incidentally, the polymer particles, which are prepared by forming a polymer into particles, are a component different from the above-described polymer dispersing agent.

Examples of the polymer particles include particles (latex particles) such as styrene-acrylic acid copolymer particles, styrene-acrylic acid-sodium acrylate copolymer particles, styrene-butadiene copolymer particles, polystyrene particles, acrylonitrile-butadiene copolymer particles, acrylic acid ester copolymer particles, polyurethane particles, polyester particles, silicone-acrylic acid copolymer particles, and acrylic-modified fluororesin particles.

Examples of the polymer particles also include core-shell polymer particles in which the particle central portion and the particle peripheral portion differ in composition from each other.

The polymer particles may be dispersed in the aqueous ink by using an emulsifier, or may be dispersed in the aqueous ink without using an emulsifier.

Examples of the emulsifier include surfactants and polymers having a hydrophilic group such as a sulfonic group or a carboxyl group (for example, a polymer in which a hydrophilic group is grafted, and a polymer synthesized from a hydrophilic-moiety-containing monomer and a hydrophobic-moiety-containing monomer).

From the viewpoint of the glossiness and anti-scratch properties of images to be formed, the polymer particles preferably have a volume-average particle size of 10 nm or more and 300 nm or less, more preferably 10 nm or more and 200 nm or less.

The volume-average particle size of the polymer particles is measured with a Microtrac UPA particle size analyzer UPA-UT151 (manufactured by Microtrac, Inc.). Specifically, the aqueous ink is measured after being diluted 1,000-fold and charged into a measurement cell. During the measurement, the value employed to be input as the viscosity is the viscosity of the diluted aqueous ink, and the value employed to be input as the particle refractive index is the refractive index of the polymer particles.

In order to suppress uneven distribution of ejected droplets, the polymer particles preferably have a glass transition temperature of 40° C. or more and 90° C. or less, more preferably 70° C. or more and 90° C. or less. On the other hand, from the viewpoint of anti-scratch properties of images to be formed, the polymer particles preferably have a glass transition temperature of −20° C. or more and 80° C. or less, more preferably −10° C. or more and 60° C. or less.

The glass transition temperature of the polymer particles is determined from a differential scanning calorimetry (DSC) curve obtained by DSC. More specifically, the glass transition temperature is determined in accordance with “extrapolated glass transition onset temperature” described in “How to Determine Glass Transition Temperature” in JIS K7121-1987 “Testing methods for transition temperatures of plastics”.

From the viewpoint of enhancement of the fixability of images to be formed, ejection stability, and film-formation properties, the polymer particle content relative to the aqueous ink is preferably 0.1 mass % or more and 10 mass % or less, more preferably 0.5 mass % or more and 5 mass % or less.

### Water

The water will be described below.

The aqueous ink used in the exemplary embodiment contains water.

In particular, from the viewpoint of preventing entry of impurities and growth of microorganisms, preferred examples of the water include ion-exchanged water, pure water, ultrapure water, distilled water, and ultrafiltered water.

In the exemplary embodiment, the solvent having a boiling point of less than 150° C. is preferably water.

From the viewpoint of drying rate and suppression of occurrence of streak unevenness in images to be formed, the water content relative to the aqueous ink is preferably 50 mass % or more and 95 mass % or less, more preferably 60 mass % or more and 90 mass % or less, particularly preferably 70 mass % or more and 85 mass % or less.

### Aqueous Organic Solvent

The aqueous organic solvent will be described below.

The aqueous ink used in the exemplary embodiment can contain an aqueous organic solvent.

Examples of the aqueous organic solvent include polyhydric alcohols, polyhydric alcohol derivatives, nitrogen-containing solvents, alcohols, and sulfur-containing solvents. Other examples of the aqueous organic solvent include propylene carbonate and ethylene carbonate.

The aqueous organic solvent is preferably an aqueous organic solvent having a boiling point of 150° C. or more.

Examples of the polyhydric alcohols include ethylene glycol, diethylene glycol, propylene glycol, butylene glycol, triethylene glycol, 1,5-pentanediol, 1,2-hexanediol, 1,2,6-hexanetriol, and glycerol.

Examples of the polyhydric alcohol derivatives include ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, and ethylene oxide adducts of diglycerol.

Examples of the nitrogen-containing solvents include pyrrolidone, N-methyl-2-pyrrolidone, cyclohexylpyrrolidone, and triethanolamine.

Examples of the alcohols include ethanol, isopropyl alcohol, butyl alcohol, and benzyl alcohol.

Examples of the sulfur-containing solvents include thiodiethanol, thiodiglycerol, sulfolane, and dimethylsulfoxide.

The aqueous organic solvent may include, as a solvent having a boiling point of less than 150° C., an alcohol.

Examples of the alcohol having a boiling point of less than 150° C. include ethanol, 1-propanol, 2-propanol, 1-butanol, 2-butanol, 2-methyl-1-propanol, and 2-methyl-2-propanol.

Such aqueous organic solvents may be used alone or in combination of two or more thereof.

Among the above-described aqueous organic solvents, from the viewpoint of adjustment of the drying rate and head clogging resistance, the aqueous ink preferably contains an aqueous organic solvent that is a polyhydric alcohol, more preferably contains an aqueous organic solvent selected from the group consisting of propylene glycol and 1,2-hexanediol, particularly preferably contains propylene glycol and 1,2-hexanediol.

The aqueous organic solvent content relative to the water is preferably 1 mass % or more and 60 mass % or less, more preferably 1 mass % or more and 40 mass % or less.

### Surfactant

The surfactant will be described below.

The aqueous ink used in the exemplary embodiment can contain a surfactant.

The aqueous ink can contain, as the surfactant, for example, a surfactant having an HLB (Hydrophile-Lipophile Balance) of 14 or less. For example, the amount of the surfactant having an HLB of 14 or less may be adjusted or plural surfactants that differ in HLB from each other may be used, which facilitate adjustment of the surface tension of the aqueous ink.

The value HLB (Hydrophile-Lipophile Balance) is defined by the following formula (Griffin method).

HLB=20×(total formula weight of hydrophilic moieties/molecular weight)

Such a surfactant is, for example, at least one selected from the group consisting of ethylene oxide adducts of acetylene glycol and polyether-modified silicones.

Such an ethylene oxide adduct of acetylene glycol is, for example, a compound having a —O—(CH₂CH₂O)ₙ—H moiety (where n represents an integer of 1 or more and 30 or less, for example) prepared by adding ethylene oxide to at least one of the hydroxyl groups of acetylene glycol.

Examples of commercially available products of ethylene oxide adducts of acetylene glycol are as follows (incidentally, values in the parentheses are HLB values described in the catalog): OLFINE E1004 (7 or more and 9 or less), OLFINE E1010 (13 or more and 14 or less), OLFINE EXP.4001 (8 or more and 11 or less), OLFINE EXP.4123 (11 or more and 14 or less), OLFINE EXP.4300 (10 or more and 13 or less), SURFYNOL 104H (4), SURFYNOL 420 (4), SURFYNOL 440 (4), and DYNOL 604 (8) (all manufactured by Nissin Chemical Industry Co., Ltd.).

Such a polyether-modified silicone is, for example, a compound in which a polyether group is grafted onto a silicone chain (polysiloxane main chain) or a compound in which a polyether group is bonded as blocks to a silicone chain (polysiloxane main chain). Examples of the polyether group include a polyoxyethylene group and a polyoxypropylene group. Examples of the polyether group also include a polyoxyalkylene group in which oxyethylene groups and oxypropylene groups are added in blocks or randomly.

Examples of commercially available products of the polyether-modified silicone are as follows (incidentally, values in the parentheses are HLB values described in the catalog): SILFACE SAG002 (12), SILFACE SAG503A (11), and SILFACE SAG005 (7) (all manufactured by Nissin Chemical Industry Co., Ltd.).

The aqueous ink may contain a surfactant other than the ethylene oxide adducts of acetylene glycol and the polyether-modified silicones.

Examples of such another surfactant include anionic surfactants, nonionic surfactants, cationic surfactants, and amphoteric surfactants; preferably, anionic surfactants and nonionic surfactants.

Examples of the anionic surfactants include alkylbenzenesulfonic acid salts, alkylphenylsulfonic acid salts, alkylnaphthalenesulfonic acid salts, higher fatty acid salts, sulfuric acid ester salts of higher fatty acid esters, sulfonic acid salts of higher fatty acid esters, sulfuric acid ester salts and sulfonic acid salts of higher alcohol ethers, higher alkyl sulfosuccinic acid salts, polyoxyethylene alkyl ether carboxylic acid salts, polyoxyethylene alkyl ether sulfuric acid salts, alkylphosphoric acid salts, and polyoxyethylene alkyl ether phosphoric acid salts.

Of these, preferred examples of the anionic surfactants include dodecylbenzenesulfonic acid salts, isopropylnaphthalenesulfonic acid salts, monobutylphenylphenol monosulfonic acid salts, monobutylbiphenylsulfonic acid salts, monobutylbiphenylsulfonic acid salts, and dibutylphenylphenol disulfonic acid salts.

Examples of the nonionic surfactants include polyoxyethylene alkyl ether, polyoxyethylene alkylphenyl ether, polyoxyethylene fatty acid ester, sorbitan fatty acid ester, polyoxyethylenesorbitan fatty acid ester, polyoxyethylenesorbitol fatty acid ester, glycerol fatty acid ester, polyoxyethyleneglycerol fatty acid ester, polyglycerol fatty acid ester, sucrose fatty acid ester, polyoxyethylenealkylamine, polyoxyethylene fatty acid amide, alkylalkanolamide, polyethylene glycol-polypropylene glycol block copolymers, and acetylene glycol.

Of these, preferred examples of the nonionic surfactants include polyoxyethylene nonylphenyl ether, polyoxyethylene octylphenyl ether, polyoxyethylene dodecylphenyl ether, polyoxyethylene alkyl ether, polyoxyethylene fatty acid ester, sorbitan fatty acid ester, polyoxyethylenesorbitan fatty acid ester, fatty acid alkylolamide, polyethylene glycol-polypropylene glycol block copolymers, and acetylene glycol.

Other examples of the nonionic surfactants include silicone surfactants such as polysiloxane oxyethylene adducts; fluorosurfactants such as perfluoroalkylcarboxylic acid salts, perfluoroalkylsulfonic acid salts, and oxyethylene perfluoroalkyl ether; and biosurfactants such as spiculisporic acid, rhamnolipid, and lysolecithin.

Such other surfactants can have Hydrophile-Lipophile Balance (HLB) values, for example, in the range of 3 or more and 20 or less in consideration of their solubility, for example.

Such surfactants may be used alone or in combination of two or more thereof.

Among the above-described surfactants, preferred surfactants are ethylene oxide adducts of acetylene glycol. More preferably, the aqueous ink contains two or more ethylene oxide adducts of acetylene glycol.

The total surfactant content relative to the aqueous ink is preferably 0.1 mass % or more and 10 mass % or less, more preferably 0.1 mass % or more and 5 mass % or less, still more preferably 0.2 mass % or more and 3 mass % or less.

### Infrared Absorbing Agent

The aqueous ink used in the exemplary embodiment can contain an infrared absorbing agent from the viewpoint of the drying rate and space savings in the inkjet recording apparatus.

Such an aqueous ink that contains an infrared absorbing agent can be dried by radiation of infrared rays using an infrared laser, for example.

The term “infrared absorbing agent” denotes a compound that absorbs infrared rays to generate heat.

The term “infrared rays” denotes a radiation in the wavelength region of 700 nm or more and 1 mm or less. The infrared absorbing agent used in the exemplary embodiment can have a maximum absorption in the wavelength region of 800 nm or more and 1,500 nm or less.

The infrared absorbing agent used in the exemplary embodiment is not particularly limited and can be selected from known infrared absorbing agents. However, from the viewpoint of not inhibiting image formation with ink, pigments such as carbon black are not preferred as the infrared absorbing agent.

The infrared absorbing agent is preferably an inorganic material or an organic dye. Specifically, the infrared absorbing agent is preferably an inorganic material from the viewpoint of amount of heat generated; or the infrared absorbing agent is preferably an organic dye from the viewpoint that radiation of near-infrared rays causes decomposition of the near-infrared absorbing agent, so that the near-infrared absorbing agent becomes light-colored and does not inhibit image formation with ink.

Preferred examples of the inorganic material include metal oxides, preferably, such as antimony tin oxide (ATO) and indium tin oxide (ITO).

Examples of the organic dye include cyanine dyes, phthalocyanine dyes, merocyanine dyes, squarylium dyes, onium compounds, indoleninecyanine, pyrylium salts, and nickel thiolate complexes. Of these, the organic dye is preferably at least one selected from the group consisting of cyanine dyes, phthalocyanine dyes, merocyanine dyes, and squarylium dyes.

In the aqueous ink used in the exemplary embodiment, infrared absorbing agents may be used alone or in combination of two or more thereof.

The infrared absorbing agent content relative to the total mass of the aqueous ink is preferably 0.001 mass % or more and 3 mass % or less, more preferably 0.005 mass % or more and 2 mass % or less. When the content satisfies such a range, a sufficiently large amount of heat is generated, and the infrared absorbing agent does not considerably affect image formation using ink.

The infrared absorbing agent may be selected from commercially available infrared absorbing agents, and examples thereof include NIR series (manufactured by Nagase ChemteX Corporation), KAYASORB series (manufactured by Nippon Kayaku Co., Ltd.), and T-1 series (manufactured by Mitsubishi Materials Electronic Chemicals Co., Ltd.).

### Other Additives

Other additives will be described below.

The aqueous ink may contain other additives.

Examples of the other additives include ink ejection improving agents (for example, polyethyleneimine, polyamines, polyvinylpyrrolidone, polyethylene glycol, ethylcellulose, and carboxymethylcellulose), conductivity/pH adjusting agents (for example, alkali metal compounds such as potassium hydroxide, sodium hydroxide, and lithium hydroxide), reactive diluent solvents, penetrants, pH buffering agents, antioxidants, fungicides, viscosity adjusting agents, conductive agents, chelating agents, and ultraviolet absorbing agents.

### Properties of Aqueous Ink

Preferred properties of the aqueous ink will be described below.

The aqueous ink preferably has a pH in the range of 4 or more and 10 or less, more preferably in the range of 5 or more and 9 or less.

The pH of the aqueous ink is a value measured in an environment at a temperature of 23±0.5° C. and at a humidity of 55±5% R.H. with a pH/conductivity meter (MPC227, manufactured by Mettler-Toledo International Inc.).

The aqueous ink preferably has a conductivity in the range of 0.01 S/m or more and 0.5 S/m or less, more preferably in the range of 0.01 S/m or more and 0.25 S/m or less, still more preferably in the range of 0.01 S/m or more and 0.20 S/m or less.

The conductivity is measured with MPC227 (pH/Conductivity Meter, manufactured by Mettler-Toledo International Inc.).

### Applications

Examples of the aqueous ink used in the exemplary embodiment include cyan inks, magenta inks, yellow inks, black inks, white inks; other inks of intermediate colors between these colors; extra-color inks such as green inks, orange inks, and violet inks; and metallic inks.

The aqueous ink set according to the exemplary embodiment may be used as an ink set that includes at least one set of such a first aqueous ink and a second aqueous ink (the aqueous ink set can be solely constituted by sets of such a first aqueous ink and a second aqueous ink).

### Ink Cartridge Set

An ink cartridge set according to the exemplary embodiment includes a first ink cartridge containing the first aqueous ink of the ink set according to the exemplary embodiment, and a second ink cartridge containing the second aqueous ink of the ink set according to the exemplary embodiment.

The ink cartridges of the ink cartridge set according to the exemplary embodiment can be provided so as to be, for example, releasably attachable to an inkjet recording apparatus.

The ink cartridge set according to the exemplary embodiment may include, in addition to the first ink cartridge and the second ink cartridge, another ink cartridge.

### Inkjet Recording Method and Inkjet Recording Apparatus

Hereinafter, an inkjet recording method and an inkjet recording apparatus according to the exemplary embodiment will be described.

The inkjet recording method according to the exemplary embodiment includes ejecting the first aqueous ink of the aqueous ink set according to the exemplary embodiment onto a recording medium, and ejecting the second aqueous ink of the aqueous ink set onto the ejected first aqueous ink such that at least the ink droplet of the first aqueous ink and the ink droplet of the second aqueous ink form a pixel.

As described above, according to the exemplary embodiment, the second aqueous ink is ejected onto the ejected first aqueous ink, so that the first aqueous ink and the second aqueous ink form a pixel. As a result, the amount of droplets adjacent to each other on the recording medium is reduced, to thereby suppress inter-droplet interference. Thus, streak unevenness is reduced and the image quality is improved.

The first aqueous ink, which has a higher drying rate, may be sufficiently air-dried before the second aqueous ink is ejected. However, from the viewpoint of reduction in the drying time and applicability of the inkjet recording method to various first aqueous inks, the inkjet recording method according to the exemplary embodiment can further include drying the ejected first aqueous ink on the recording medium prior to the formation of the pixel.

The inkjet recording method according to the exemplary embodiment may include individually ejecting aqueous inks of plural colors.

In the inkjet recording method according to the exemplary embodiment, the volume ratio of the ink droplet V¹ of the first aqueous ink forming a pixel to the ink droplet V² of the second aqueous ink forming the pixel is, from the viewpoint of suppression of occurrence of streak unevenness in images to be formed, image density, and drying rate, preferably 0.5≦V¹/V²≦2, more preferably 0.80≦V¹/V²≦1.25, particularly preferably 0.90≦V¹/V²≦1.11.

The inkjet recording apparatus according to the exemplary embodiment contains the aqueous ink set according to the exemplary embodiment and includes a first ejection head that ejects the first aqueous ink onto a surface of a recording medium, and a second ejection head that is disposed downstream of the first ejection head in a transport direction of the recording medium and that ejects the second aqueous ink after the ejection of the first aqueous ink.

The inkjet recording apparatus according to the exemplary embodiment is suitably applicable to the inkjet recording method according to the exemplary embodiment.

The inkjet recording apparatus according to the exemplary embodiment can further include a drying unit that is disposed upstream of the second ejection head in the transport direction of the recording medium, and that dries the ejected first aqueous ink.

Examples of the drying unit include air-drying units such as air blowers; thermal drying units such as heating rollers, heaters, and infrared heaters; and drying units of radiating infrared rays such as an infrared laser to the first aqueous ink containing an infrared absorbing agent.

The drying temperature during drying of the aqueous ink is not particularly limited, and the aqueous ink may be dried at room temperature or under heating. During the drying, the surface temperature of the recording medium is preferably 35° C. or more and 200° C. or less, more preferably 40° C. or more and 150° C. or less.

The inkjet recording apparatus according to the exemplary embodiment may include plural ejection heads that individually eject aqueous inks of plural colors.

The inkjet recording apparatus according to the exemplary embodiment can be an apparatus in which an ink droplet ejected by the first ejection head and an ink droplet ejected by the second ejection head form a pixel.

The recording medium used in the exemplary embodiment is not particularly limited, and can be selected from known recording media.

The inkjet recording method according to the exemplary embodiment and the inkjet recording apparatus according to the exemplary embodiment enable suppression of occurrence of image unevenness even on low-permeability or impermeable recording media in which streak unevenness tends to occur.

Examples of permeable recording media include plain paper. Specifically, the permeable recording media means recording media that have a maximum ink absorption amount of more than 15 ml/m² measured with a dynamic scanning liquid absorptometer within a contact time of 500 ms.

On the other hand, examples of the impermeable recording media include resin films. Specifically, the impermeable recording media means recording media that have a maximum ink absorption amount of less than 3 ml/m² measured with a dynamic scanning liquid absorptometer within a contact time of 500 ms.

Examples of the low-permeability recording media include coated papers such as coat paper, art paper, and cast coated paper. Specifically, the low-permeability recording media means recording media that have a maximum ink absorption amount in the range of 3 ml/m² or more and 15 ml/m² or less measured with a dynamic scanning liquid absorptometer within a contact time of 500 ms.

The recording media are preferably coated papers and resin films, more preferably coated papers.

The inkjet recording method according to the exemplary embodiment and the inkjet recording apparatus according to the exemplary embodiment are applicable to a configuration in which recording is carried out only on a single surface of a recording medium, and are also applicable to a configuration in which recording is carried out on both surfaces of a recording medium by means of a mechanism of turning over a recording medium on a single surface of which recording has been carried out.

Hereinafter, an example of a recording apparatus according to the exemplary embodiment will be described with reference to the drawing.

FIGURE is a schematic view illustrating an example of the configuration of the inkjet recording apparatus according to the exemplary embodiment.

Referring to FIGURE, an inkjet recording apparatus 10 includes first ejection heads 121K, 121Y, 121M, and 121C, and second ejection heads 122K, 122Y, 122M, and 122C that eject aqueous inks (hereafter also referred to as “inks”) onto a recording medium P. The inkjet recording apparatus 10 is an inkjet recording apparatus that includes an ejection unit of ejecting aqueous inks onto the recording medium P. In this way, an image can be recorded with the aqueous inks on the recording medium P.

Specifically, the inkjet recording apparatus 10 includes, for example, an image recording unit 12 that records an image on continuous paper (hereafter also referred to as the “continuous paper P”) as the recording medium P.

The inkjet recording apparatus 10 includes a pre-process unit 14 that stores the continuous paper P to be supplied to the image recording unit 12, and a buffer unit 16 that adjusts, for example, the amount of transporting the continuous paper P supplied from the pre-process unit 14 to the image recording unit 12. The buffer unit 16 is disposed between the image recording unit 12 and the pre-process unit 14.

The recording apparatus 10 includes, for example, a post-process unit 18 that stores the continuous paper P discharged from the image recording unit 12, and a buffer unit 20 that adjusts, for example, the amount of transporting the continuous paper P discharged from the image recording unit 12 to the post-process unit 18. The buffer unit 20 is disposed between the image recording unit 12 and the post-process unit 18.

The inkjet recording apparatus 10 includes a cooling unit 22 that is disposed between the image recording unit 12 and the buffer unit 20, and that cools the continuous paper P transported out of the image recording unit 12.

The image recording unit 12 includes, for example, roller members (illustrated without reference signs) that guide the continuous paper P along a transport path 124 of the continuous paper P, and an ejection unit 121 that ejects aqueous inks (droplets of the aqueous inks), to record an image, onto the continuous paper P, which is transported along the transport path 124 of the continuous paper P.

The ejection unit 121 includes the first ejection heads 121K, 121Y, 121M, and 121C and the second ejection heads 122K, 122Y, 122M, and 122C, which eject aqueous inks onto the continuous paper P. Each of the first ejection heads and the second ejection heads is, for example, a large-width recording head designed to have an effective recording region (region where ink-ejection nozzles are arranged) whose width is equal to or larger than the width of the continuous paper P (its breadth in the direction intersecting (for example, orthogonal to) the direction of transporting the continuous paper P).

However, the first ejection heads and the second ejection heads are not limited to such recording heads, and may be a small-width ejection head designed so as to have a width smaller than the width of the continuous paper P, and move in the width direction of the continuous paper P and eject an aqueous ink (what is called, the carriage-type ejection head).

The first ejection heads 121K, 121Y, 121M, and 121C and the second ejection heads 122K, 122Y, 122M, and 122C may be of known types: the ejection heads may be designed as, what is called, thermal ejection heads, which eject droplets of aqueous inks by application of heat, or may be designed as, what is called, piezoelectric ejection heads, which eject droplets of aqueous inks by application of pressure.

The inkjet recording apparatus 10 includes, for example, the first ejection head 121K and the second ejection head 122K, which eject aqueous inks onto the continuous paper P to record a K (black)-color image; the first ejection head 121Y and the second ejection head 122Y, which record a Y (yellow)-color image; the first ejection head 121M and the second ejection head 122M, which record a M (magenta)-color image; and the first ejection head 121C and the second ejection head 122C, which record a C (cyan)-color image. The first ejection head 121K, the first ejection head 121Y, the first ejection head 121M, the first ejection head 121C, the second ejection head 122K, the second ejection head 122Y, the second ejection head 122M, and the second ejection head 122C are arranged in this order in the direction of transporting the continuous paper P (hereafter sometimes simply referred to as the “paper transport direction”) from an upstream position to a downstream position so as to face the continuous paper P. When the ejection heads are described without distinction between K, Y, M, and C, these characters K, Y, M, and C attached to the reference numerals will be omitted.

The inkjet recording apparatus 10 includes a drying unit H disposed, in the paper transport direction, between the first ejection head 121C and the second ejection head 122K. The drying unit H includes therein a heating source (for example, a halogen heater, an infrared heater, or a laser radiation unit: not shown). The drying unit H is used to dry the ejected first aqueous inks.

The ejection unit 121 is not limited to the above-described configuration in which four first ejection heads and four second ejection heads corresponding to the four colors are arranged. Depending on the purpose, the ejection unit 121 may have a configuration in which four or more first ejection heads and four or more second ejection heads corresponding to four or more colors including another intermediate color are arranged.

The first ejection heads 121K, 121Y, 121M, and 121C and the second ejection heads 122K, 122Y, 122M, and 122C may be, for example, a low-resolution ejection head (for example, a 600 dpi ejection head) that ejects an aqueous ink in the range of an ink-droplet amount or more and 15 pl or less, or a high-resolution ejection head (for example, a 1,200 dpi ejection head) that ejects an aqueous ink in the range of an ink-droplet amount or more and less than 10 pl. The ejection unit 121 may include both of such a low-resolution ejection head and such a high-resolution ejection head. The unit “dpi” means “dot per inch”.

The ejection unit 121 includes, for example, a drying drum 126 (an example of the drying unit), which is disposed downstream of the second ejection heads 122K, 122Y, 122M, and 122C in the paper transport direction, along which the continuous paper P is run with its back surface in contact with the drying drum 126, and which is driven to rotate in contact with the continuous paper P being transported and dries the images (aqueous inks) on the continuous paper P.

The drying drum 126 includes therein a heating source (for example, a halogen heater: not shown). The drying drum 126 dries the images (aqueous inks) on the continuous paper P by heating with the heating source.

At positions around the drying drum 126, hot-air blowing units 128 (an example of the drying unit), which dry the images (aqueous inks) on the continuous paper P, are disposed. Hot air applied by the hot-air blowing units 128 is used to dry the images (aqueous inks) on the continuous paper P, which is run along the drying drum 126.

The pre-process unit 14 includes a supply roller 14B around which the continuous paper P supplied to the image recording unit 12 is wound. The supply roller 14B is rotatably supported by a frame member (not shown).

The buffer unit 16 includes, for example, a first pass roller 16A, a dancer roller 16B, and a second pass roller 16C arranged in the paper transport direction. The dancer roller 16B moves upward or downward in FIGURE to thereby adjust the tension of the continuous paper P transported to the image recording unit 12 and adjust the amount of transporting the continuous paper P.

The post-process unit 18 includes a winding roller 18A as an example of a transport unit that winds up the continuous paper P on which images have been recorded. The winding roller 18A is rotated by a rotation force applied by a motor (not shown), so that the continuous paper P is transported along the transport path 124.

The buffer unit 20 includes, for example, a first pass roller 20A, a dancer roller 20B, and a second pass roller 20C arranged in the paper transport direction. The dancer roller 20B moves upward or downward in FIGURE, to thereby adjust the tension of the continuous paper P discharged to the post-process unit 18 and adjust the amount of transporting the continuous paper P.

The cooling unit 22 includes plural cooling rollers 22A. The continuous paper P is transported over the plural cooling rollers 22A, so that the continuous paper P is cooled.

Hereinafter, operations of the inkjet recording apparatus 10 according to the exemplary embodiment (recording apparatus) will be described.

In the inkjet recording apparatus 10 according to the exemplary embodiment, the continuous paper P is first transported from the supply roller 14B of the pre-process unit 14, through the buffer unit 16, to the image recording unit 12.

Subsequently, in the image recording unit 12, the first ejection heads 121K, 121Y, 121M, and 121C of the ejection unit 121 individually eject the first aqueous inks of corresponding colors onto the continuous paper P. Subsequently, the drying unit H is used to dry the ejected first aqueous inks of colors. Furthermore, the second ejection heads 122K, 122Y, 122M, and 122C each eject the second aqueous ink onto at least the dried first aqueous ink having a hue in the same category as in the second aqueous ink. As a result, the aqueous inks form images on the continuous paper P. The drying drum 126 is subsequently used to dry the images (aqueous inks) on the continuous paper P from the back-surface side (a surface side opposite to the recording surface) of the continuous paper P. The hot-air blowing units 128 are used to dry the aqueous inks (images) ejected onto the continuous paper P, from the front-surface (recording-surface) side of the continuous paper P. That is, the drying drum 126 and the hot-air blowing units 128 are used to dry the ejected inks on the continuous paper P.

Subsequently, in the cooling unit 22, the cooling rollers 22A are used to cool the continuous paper P having the recorded images thereon.

Subsequently, the continuous paper P having the recorded images thereon is passed through the buffer unit 20, and wound up by the winding roller 18A in the post-process unit 18.

In the above-described manner, images formed from aqueous inks are recorded on the continuous paper P as the recording medium P.

Incidentally, the inkjet recording apparatus 10 has been described about the configuration in which the ejection unit 121 ejects ink droplets directly onto a surface of the recording medium P. The inkjet recording apparatus is not limited to this configuration and may employ a configuration in which, for example, ink droplets are ejected onto an intermediate transfer body, and the ink droplets on the intermediate transfer body are transferred onto the recording medium P.

The inkjet recording apparatus 10 has been described about the configuration in which images are formed by ejecting inks onto the continuous paper P as the recording medium P. Alternatively, the inkjet recording apparatus may have a configuration in which images are recorded by ejecting inks onto separate sheets of paper as the recording medium P.

The above-described exemplary embodiment is not limited to the described configurations and is obviously embodied as long as it falls within the scope of the present invention.

### EXAMPLES

Hereinafter, the present invention will be described further in detail with reference to Examples. However, the present invention is not limited to these Examples. The term “parts” represents “parts by mass” unless otherwise specified.

### Example 1

### <Preparation of Cyan Ink 1>

Pigment Blue 15:4 (cyan pigment, C.I. Pigment Blue-15:4, manufactured by Dainichiseika Color & Chemicals Mfg. Co., Ltd.): 3.5 mass %

Styrene-acrylic acid salt copolymer (pigment dispersing agent, manufactured by BASF): 0.4 mass %

Propylene glycol (manufactured by Wako Pure Chemical Industries, Ltd., boiling point: 188.2° C.): 7 mass %

1,2-Hexanediol (manufactured by Wako Pure Chemical Industries, Ltd., boiling point: 223° C.): 3 mass %

Polyacrylate emulsion (solid content: 25%, manufactured by The Nippon Synthetic Chemical Industry Co., Ltd.): 4 mass %

OLFINE E1010 (surfactant, manufactured by Nissin Chemical Industry Co., Ltd.): 0.6 mass %

OLFINE E1004 (surfactant, manufactured by Nissin Chemical Industry Co., Ltd.): 0.2 mass %

Pure water: 81.3 mass %

The above-listed components are mixed together, and then filtered through a 5-μm filter to obtain Cyan ink 1.

### <Preparation of Cyan Ink 2>

Pigment Blue 15:4 (cyan pigment, manufactured by Dainichiseika Color & Chemicals Mfg. Co., Ltd.): 5.5 mass %

Styrene-acrylic acid salt copolymer (pigment dispersing agent, manufactured by BASF): 0.5 mass %

Propylene glycol (manufactured by Wako Pure Chemical Industries, Ltd., boiling point: 188.2° C.): 10 mass %

1,2-Hexanediol (manufactured by Wako Pure Chemical Industries, Ltd., boiling point: 223° C.): 5 mass %

Polyacrylate emulsion (solid content: 25%, manufactured by The Nippon Synthetic Chemical Industry Co., Ltd.): 4 mass %

OLFINE E1010 (surfactant, manufactured by Nissin Chemical Industry Co., Ltd.): 0.7 mass %

OLFINE E1004 (surfactant, manufactured by Nissin Chemical Industry Co., Ltd.): 0.3 mass %

Pure water: 74.0 mass %

The above-listed components are mixed together, and then filtered through a 5-μm filter to obtain Cyan ink 2.

Cyan ink 1 and Cyan ink 2 are each dropped in an amount of 10 mg on a glass plate, and the inks are heated in an open state at 40° C. for 20 minutes. The ink evaporation ratio of Cyan ink 1 is found to be 83 mass %. The ink evaporation ratio of Cyan ink 2 is found to be 75.5 mass %.

### <Image Formation>

Cyan ink 1 and Cyan ink 2 prepared above are used to form an image with the following recording apparatus.

A 1 cm×1 cm solid patch at a resolution of 600×600 dpi (dot per inch) is printed with Cyan ink 1 ejected as 5-pl droplets by a first head, on OK Topkote+(manufactured by Oji Paper Co., Ltd.) paper, and subsequently dried with a small infrared (IR) heater. Similarly, a solid patch is then printed with Cyan ink 2 ejected as 5-pl droplets from a second head, on the pixels formed from Cyan ink 1. The solid patch is then dried with the IR heater to obtain a printed image.

### <Evaluations>

### —Evaluation for Streak Unevenness—

The obtained printed image having the solid patch is visually evaluated.

A: The whole solid patch appears uniform.

B: The patch appears to have some variations in the density, but does not have clear streak unevenness.

C: A clear white streak is visually recognized.

### —Evaluation for Image Density—

The obtained printed image having the solid patch is measured for the image density of the cyan color with an image densitometer X-Rite 504 (manufactured by X-Rite Inc.) set with an aperture size of 3.4 mm.

### —Evaluation for Clogging Resistance—

The evaluation is carried out with the above-described recording apparatus: printing is continuously carried out for 1 minute such that a portion of the head is used to print a solid pattern and the other portion is operated for dummy jetting; subsequently, the whole surface of the head is used to print a quarter pattern.

The portion used for printing the solid pattern and the other portion during the continuous printing are compared on the basis of the quarter pattern printed after the continuous printing, and are evaluated on the basis of the following criteria.

A: Printing without any missing dot is carried out from the first dot, and displacement of dots does not occur.

B: Printing without any missing dot is carried out from the first dot, but slight displacement of dots occurs.

C: Displacement of dots by the distance of at least 1 dot and missing of dots are observed, and the head is clogged.

### Comparative Example 1

### <Preparation of Cyan Ink 3>

Pigment Blue 15:4 (cyan pigment, manufactured by Dainichiseika Color & Chemicals Mfg. Co., Ltd.): 4.5 mass %

Styrene-acrylic acid salt copolymer (pigment dispersing agent, manufactured by BASF): 0.5 mass %

Propylene glycol (manufactured by Wako Pure Chemical Industries, Ltd., boiling point: 188.2° C.): 10 mass %

1,2-Hexanediol (manufactured by Wako Pure Chemical Industries, Ltd., boiling point: 223° C.): 5 mass %

Polyacrylate emulsion (solid content: 25%, manufactured by The Nippon Synthetic Chemical Industry Co., Ltd.): 4 mass %

OLFINE E1010 (surfactant, manufactured by Nissin Chemical Industry Co., Ltd.): 0.7 mass %

OLFINE E1004 (surfactant, manufactured by Nissin Chemical Industry Co., Ltd.): 0.3 mass %

Pure water: 75 mass %

The above-listed components are mixed together, and then filtered through a 5-μm filter to obtain Cyan ink 3.

<Image Formation>

A solid patch is printed with Cyan ink 3 ejected as 10-pl droplets by the following recording apparatus, on OK Topkote+(manufactured by Oji Paper Co., Ltd.) paper. The solid patch is then dried with an IR heater to obtain a printed image.

### <Evaluations>

Evaluations are carried out as in Example 1. The evaluation results are described in Table 1 below.

### Example 2

### <Preparation of Magenta Ink 1>

Pigment Red 122 (magenta pigment, manufactured by DIC Corporation): 5 mass %

Styrene-acrylic acid salt copolymer (pigment dispersing agent, manufactured by BASF): 0.5 mass %

Propylene glycol (manufactured by Wako Pure Chemical Industries, Ltd., boiling point: 188.2° C.): 8 mass %

1,2-Hexanediol (manufactured by Wako Pure Chemical Industries, Ltd., boiling point: 223° C.): 2 mass %

Polyacrylate emulsion (solid content: 30%, manufactured by The Nippon Synthetic Chemical Industry Co., Ltd.): 3 mass %

OLFINE E1010 (surfactant, manufactured by Nissin Chemical Industry Co., Ltd.): 0.5 mass %

OLFINE E1004 (surfactant, manufactured by Nissin Chemical Industry Co., Ltd.): 0.3 mass %

Pure water: 80.7 mass %

The above-listed components are mixed together, and then filtered through a 5-μm filter to obtain Magenta ink 1.

### <Preparation of Magenta Ink 2>

Pigment Red 122 (magenta pigment, manufactured by DIC Corporation): 6.5 mass %

Styrene-acrylic acid salt copolymer (pigment dispersing agent, manufactured by BASF): 0.6 mass %

Propylene glycol (manufactured by Wako Pure Chemical Industries, Ltd., boiling point: 188.2° C.): 12 mass %

1,2-Hexanediol (manufactured by Wako Pure Chemical Industries, Ltd., boiling point: 223° C.): 1 mass %

Dipropylene glycol monobutyl ether (manufactured by Wako Pure Chemical Industries, Ltd., boiling point: 231° C.) 3 mass %

Polyacrylate emulsion (solid content: 30%, manufactured by The Nippon Synthetic Chemical Industry Co., Ltd.): 4 mass %

OLFINE E1010 (surfactant, manufactured by Nissin Chemical Industry Co., Ltd.): 0.65 mass %

OLFINE E1004 (surfactant, manufactured by Nissin Chemical Industry Co., Ltd.): 0.35 mass %

Pure water: 71.9 mass %

The above-listed components are mixed together, and then filtered through a 5-μm filter to obtain Magenta ink 2.

Magenta ink 1 and Magenta ink 2 are each dropped in an amount of 10 mg on a glass plate, and the inks are heated in an open state at 40° C. for 20 minutes. The ink evaporation ratio of Magenta ink 1 is found to be 81.5 mass %. The ink evaporation ratio of Magenta ink 2 is found to be 72.4 mass %.

### <Image Formation>

Printing with Magenta ink 1 and Magenta ink 2 prepared above is carried out as in Example 1 to obtain a printed image.

### <Evaluations>

Evaluations are carried out as in Example 1 except that, in Evaluation for Image Density, the density of the magenta color is measured. The evaluation results are described in Table 1 below.

### Example 3

### <Preparation of Yellow ink 1>

Pigment Yellow 74 (yellow pigment, manufactured by DIC Corporation): 4.2 mass %

Styrene-methacrylic acid ethyl ester-methacrylic acid salt copolymer (pigment dispersing agent, manufactured by BASF): 0.5 mass %

Propylene glycol (manufactured by Wako Pure Chemical Industries, Ltd., boiling point: 188.2° C.): 7 mass %

1,2-Hexanediol (manufactured by Wako Pure Chemical Industries, Ltd., boiling point: 223° C.): 1.5 mass %

Polyacrylate emulsion (solid content: 37%, manufactured by The Nippon Synthetic Chemical Industry Co., Ltd.): 2.8 mass %

OLFINE E1010 (surfactant, manufactured by Nissin Chemical Industry Co., Ltd.): 0.6 mass %

OLFINE E1004 (surfactant, manufactured by Nissin Chemical Industry Co., Ltd.): 0.2 mass %

Pure water: 83.2 mass %

The above-listed components are mixed together, and then filtered through a 5-μm filter to obtain Yellow ink 1.

### <Preparation of Yellow ink 2>

Pigment Yellow 74 (yellow pigment, manufactured by DIC Corporation): 5.4 mass %

Styrene-methacrylic acid ethyl ester-methacrylic acid salt copolymer (pigment dispersing agent, manufactured by BASF): 0.6 mass %

Propylene glycol (manufactured by Wako Pure Chemical Industries, Ltd., boiling point: 188.2° C.): 15 mass %

1,2-Hexanediol (manufactured by Wako Pure Chemical Industries, Ltd., boiling point: 223° C.): 1.5 mass %

Polyacrylate emulsion (solid content: 37%, manufactured by The Nippon Synthetic Chemical Industry Co., Ltd.): 3.0 mass %

OLFINE E1010 (surfactant, manufactured by Nissin Chemical Industry Co., Ltd.): 0.7 mass %

OLFINE E1004 (surfactant, manufactured by Nissin Chemical Industry Co., Ltd.): 0.3 mass %

Pure water: 73.5 mass %

The above-listed components are mixed together, and then filtered through a 5-μm filter to obtain Yellow ink 2.

Yellow ink 1 and Yellow ink 2 are each dropped in an amount of 10 mg on a glass plate, and the inks are heated in an open state at 40° C. for 20 minutes. The ink evaporation ratio of Yellow ink 1 is found to be 84.5 mass %. The ink evaporation ratio of Yellow ink 2 is found to be 74.7 mass %.

### <Image Formation>

Yellow ink 1 and Yellow ink 2 prepared above are used to form an image with the following recording apparatus.

A 1 cm×1 cm solid patch at a resolution of 600×600 dpi is printed with Yellow ink 1 ejected as 6-pl droplets by a first head, on OK Topkote+(manufactured by Oji Paper Co., Ltd.) paper, and subsequently dried with a small IR heater. Similarly, a solid patch is then printed with Yellow ink 2 ejected as 4.5-pl droplets by a second head, on the pixels formed from Yellow ink 1. The solid patch is then dried with the IR heater to obtain a printed image.

### <Evaluations>

Evaluations are carried out as in Example 1 except that, in Evaluation for Image Density, the density of the yellow color is measured. The evaluation results are described in Table 1 below.

### Example 4

### <Preparation of Cyan Ink 4>

Pigment Blue 15:3 (cyan pigment, manufactured by DIC Corporation): 4 mass %

Styrene-acrylic acid butyl ester-acrylic acid salt copolymer (pigment dispersing agent, manufactured by BASF): 0.4 mass %

Propylene glycol (manufactured by Wako Pure Chemical Industries, Ltd., boiling point: 188.2° C.): 14 mass %

1,2-Hexanediol (manufactured by Wako Pure Chemical Industries, Ltd., boiling point: 223° C.): 1.0 mass %

Polyacrylate emulsion (solid content: 25%, manufactured by The Nippon Synthetic Chemical Industry Co., Ltd.): 4 mass %

OLFINE E1010 (surfactant, manufactured by Nissin Chemical Industry Co., Ltd.): 0.6 mass %

OLFINE E1004 (surfactant, manufactured by Nissin Chemical Industry Co., Ltd.): 0.2 mass %

Pure water: 75.8 mass %

The above-listed components are mixed together, and then filtered through a 5-μm filter to obtain Cyan ink 4.

<Preparation of Cyan Ink 5>

Pigment Blue 15:3 (cyan pigment, manufactured by DIC Corporation): 5.5 mass %

Styrene-acrylic acid butyl ester-acrylic acid salt copolymer (pigment dispersing agent, manufactured by BASF): 0.6 mass %

Propylene glycol (manufactured by Wako Pure Chemical Industries, Ltd., boiling point: 188.2° C.): 15 mass %

1,2-Hexanediol (manufactured by Wako Pure Chemical Industries, Ltd., boiling point: 223° C.): 2 mass %

Diethylene glycol isopropyl ether (manufactured by Nippon Nyukazai Co., Ltd., boiling point: 207° C.): 3 mass %

Polyacrylate emulsion (solid content: 25%, manufactured by The Nippon Synthetic Chemical Industry Co., Ltd.): 4 mass %

OLFINE E1010 (surfactant, manufactured by Nissin Chemical Industry Co., Ltd.): 0.7 mass %

OLFINE E1004 (surfactant, manufactured by Nissin Chemical Industry Co., Ltd.): 0.3 mass %

Pure water: 68.9 mass %

The above-listed components are mixed together, and then filtered through a 5-μm filter to obtain Cyan ink 5.

Cyan ink 4 and Cyan ink 5 are each dropped in an amount of 10 mg on a glass plate, and the inks are heated in an open state at 40° C. for 20 minutes. The ink evaporation ratio of Cyan ink 4 is found to be 78.1 mass %. The ink evaporation ratio of Cyan ink 5 is found to be 69.8 mass %.

### <Image Formation>

Cyan ink 4 and Cyan ink 5 prepared above are used to form an image with the following recording apparatus.

A 1 cm×1 cm solid patch at a resolution of 600×600 dpi is formed with Cyan ink 4 ejected as 5-pl droplets by a first head, on OK Topkote +(manufactured by Oji Paper Co., Ltd.) paper, and subsequently dried with a small infrared (IR) heater. Similarly, a solid patch is then formed with Cyan ink 5 ejected as 5-pl droplets by a second head, on the pixels formed from Cyan ink 4. The solid patch is then dried with the IR heater to obtain a printed image.

### <Evaluations>

Evaluations are carried out as in Example 1. The evaluation results are described in Table 1 below.

### Example 5

### <Preparation of Magenta Ink 3>

Solid solution of Pigment Red 122/Pigment Violet 19 (magenta pigment, manufactured by DIC Corporation): 5 mass %

Acrylic acid benzylmethyl ester-methacrylic acid ethyl ester-acrylic acid salt copolymer (pigment dispersing agent, manufactured by BASF): 0.5 mass %

Ethylene glycol (manufactured by Wako Pure Chemical Industries, Ltd., boiling point: 197° C.): 4 mass %

Propylene glycol monomethyl ether (boiling point: 120° C.) : 5 mass %

1,2-Hexanediol (manufactured by Wako Pure Chemical Industries, Ltd., boiling point: 223° C.): 0.5 mass %

Polyurethane emulsion (solid content: 25%, manufactured by The Nippon Synthetic Chemical Industry Co., Ltd.): 4 mass %

OLFINE E1010 (surfactant, manufactured by Nissin Chemical Industry Co., Ltd.): 0.5 mass %

OLFINE E1004 (surfactant, manufactured by Nissin Chemical Industry Co., Ltd.): 0.2 mass %

Pure water: 80.3 mass %

The above-listed components are mixed together, and then filtered through a 5-μm filter to obtain Magenta ink 3.

### <Preparation of Magenta Ink 4>

Solid solution of Pigment Red 122/Pigment Violet 19 (magenta pigment, manufactured by DIC Corporation): 6 mass %

Acrylic acid benzylmethyl ester-methacrylic acid ethyl ester-acrylic acid salt copolymer (pigment dispersing agent, manufactured by BASF): 0.6 mass %

Ethylene glycol (manufactured by Wako Pure Chemical Industries, Ltd., boiling point: 197° C.): 10 mass %

Propylene glycol monomethyl ether (boiling point: 120° C.): 7 mass %

1,2-Hexanediol (manufactured by Wako Pure Chemical Industries, Ltd., boiling point: 223° C.): 1 mass %

Polyurethane emulsion (solid content: 25%, manufactured by The Nippon Synthetic Chemical Industry Co., Ltd.): 4 mass %

OLFINE E1010 (surfactant, manufactured by Nissin Chemical Industry Co., Ltd.): 0.6 mass %

OLFINE E1004 (surfactant, manufactured by Nissin Chemical Industry Co., Ltd.): 0.4 mass %

Pure water: 70.4 mass %

The above-listed components are mixed together, and then filtered through a 5-μm filter to obtain Magenta ink 4.

Magenta ink 3 and Magenta ink 4 are each dropped in an amount of 10 mg on a glass plate, and the inks are heated in an open state at 40° C. for 20 minutes. The ink evaporation ratio of Magenta ink 3 is found to be 88.2 mass %. The ink evaporation ratio of Magenta ink 4 is found to be 79.5 mass %.

### <Image Formation>

Magenta ink 3 and Magenta ink 4 prepared above are used for printing as in Example 2 to form a printed image.

### <Evaluations>

The printed image is evaluated as in Example 2. The evaluation results are described in Table 1 below.

Example 5 is evaluated as A in terms of streak unevenness. The image density is found to be 1.38. Example 5 is evaluated as B in terms of clogging resistance.

### Comparative Example 2

### <Preparation of Cyan Ink 6>

Pigment Blue 15:4 (cyan pigment, manufactured by Dainichiseika Color & Chemicals Mfg. Co., Ltd.): 5.5 mass %

Styrene-acrylic acid salt copolymer (pigment dispersing agent, manufactured by BASF): 0.5 mass %

Glycerol (manufactured by Wako Pure Chemical Industries, Ltd., boiling point: 290° C.): 28 mass %

1,2-Hexanediol (manufactured by Wako Pure Chemical Industries, Ltd., boiling point: 223° C.): 0.5 mass %

Polyurethane emulsion (solid content: 25%, manufactured by The Nippon Synthetic Chemical Industry Co., Ltd.): 6 mass %

OLFINE E1010 (surfactant, manufactured by Nissin Chemical Industry Co., Ltd.): 0.6 mass %

OLFINE E1004 (surfactant, manufactured by Nissin Chemical Industry Co., Ltd.): 0.3 mass %

Pure water: 58.6 mass %

The above-listed components are mixed together, and then filtered through a 5-μm filter to obtain Cyan ink 6.

Cyan ink 6 is dropped in an amount of 10 mg on a glass plate, and the ink in an open state is heated at 40° C. for 20 minutes. The ink evaporation ratio of Cyan ink 6 is found to be 62.5 mass %.

### <Image Formation>

Cyan ink 6 prepared above is used to print an image with the following recording apparatus.

A 1 cm×1 cm solid patch at a resolution of 600×600 dpi is printed with Cyan ink 6 ejected as 5-pl droplets by a first head, on OK Topkote+(manufactured by Oji Paper Co., Ltd.) paper, and subsequently dried with a small IR heater. Similarly, a solid patch is then printed with the same Cyan ink 6 ejected as 5-pl droplets by a second head, on the pixels formed from Cyan ink 6 ejected by the first head. The solid patch is then dried with the IR heater to obtain a printed image.

### <Evaluations>

Evaluations are carried out as in Example 1. The evaluation results are described in Table 1 below.

### Comparative Example 3

### <Preparation of Cyan Ink 7>

Pigment Blue 15:3 (cyan pigment, manufactured by DIC Corporation): 5.5 mass %

Styrene-acrylic acid butyl ester-acrylic acid salt copolymer (pigment dispersing agent, manufactured by BASF): 0.5 mass %

Glycerol (manufactured by Wako Pure Chemical Industries, Ltd., boiling point: 290° C.): 13 mass %

Propylene glycol (manufactured by Wako Pure Chemical Industries, Ltd., boiling point: 188.2° C.): 7 mass %

1,2-Hexanediol (manufactured by Wako Pure Chemical Industries, Ltd., boiling point: 223° C.): 1.0 mass %

Polyester emulsion (solid content: 20%, manufactured by The Nippon Synthetic Chemical Industry Co., Ltd.): 4 mass %

OLFINE E1010 (surfactant, manufactured by Nissin Chemical Industry Co., Ltd.): 0.55 mass %

OLFINE E1004 (surfactant, manufactured by Nissin Chemical Industry Co., Ltd.): 0.35 mass %

Pure water: 68.1 mass %

The above-listed components are mixed together, and then filtered through a 5-μm filter to obtain Cyan ink 7.

<Preparation of Cyan Ink 8>

Pigment Blue 15:3 (cyan pigment, manufactured by DIC Corporation): 3.5 mass %

Styrene-acrylic acid butyl ester-acrylic acid salt copolymer (pigment dispersing agent, manufactured by BASF): 0.3 mass %

Glycerol (manufactured by Wako Pure Chemical Industries, Ltd., boiling point: 290° C.): 6 mass %

Propylene glycol (manufactured by Wako Pure Chemical Industries, Ltd., boiling point: 188.2° C.): 5 mass %

1,2-Hexanediol (manufactured by Wako Pure Chemical Industries, Ltd., boiling point: 223° C.): 0.5 mass %

Polyacrylate emulsion (solid content: 25%, manufactured by The Nippon Synthetic Chemical Industry Co., Ltd.): 4 mass %

OLFINE E1010 (surfactant, manufactured by Nissin Chemical Industry Co., Ltd.): 0.7 mass %

OLFINE E1004 (surfactant, manufactured by Nissin Chemical Industry Co., Ltd.): 0.3 mass %

Pure water: 79.7 mass %

The above-listed components are mixed together, and then filtered through a 5-μm filter to obtain Cyan ink 8.

Cyan ink 7 and Cyan ink 8 are each dropped in an amount of 10 mg on a glass plate, and the inks are heated in an open state at 40° C. for 20 minutes. The ink evaporation ratio of Cyan ink 7 is found to be 68.5 mass %. The ink evaporation ratio of Cyan ink 8 is found to be 81.7 mass %.

### <Image Formation>

Cyan ink 7 and Cyan ink 8 prepared above are used to form an image with the following recording apparatus.

A 1 cm×1 cm solid patch at a resolution of 600×600 dpi is printed with Cyan ink 7 ejected as 5-pl droplets by a first head, on OK Topkote+(manufactured by Oji Paper Co., Ltd.) paper, and subsequently dried with a small IR heater. Similarly, a solid patch is then printed with Cyan ink 8 ejected as 5-pl droplets by a second head, on the pixels formed from Cyan ink 7. The solid patch is then dried with the IR heater to obtain a printed image.

### <Evaluations>

Evaluations are carried out as in Example 1. The evaluation results are described in Table 1 below.

### Example 6

### <Preparation of Cyan Ink 9>

Pigment Blue 15:3 (cyan pigment, manufactured by DIC Corporation): 4 mass %

Styrene-methacrylic acid ethyl ester-methacrylic acid salt copolymer (pigment dispersing agent, manufactured by BASF): 0.5 mass %

Propylene glycol (manufactured by Wako Pure Chemical Industries, Ltd., boiling point: 188.2° C.): 6 mass %

Ethylene glycol (manufactured by Wako Pure Chemical Industries, Ltd., boiling point: 197° C.): 4 mass %

1,2-Hexanediol (manufactured by Wako Pure Chemical Industries, Ltd., boiling point: 223° C.): 1.0 mass %

Polyurethane emulsion (solid content: 25%, manufactured by The Nippon Synthetic Chemical Industry Co., Ltd.): 4 mass %

Diimonium compound (infrared absorbing agent, manufactured by Nippon Kayaku Co., Ltd.): 0.005 mass %

OLFINE E1010 (surfactant, manufactured by Nissin Chemical Industry Co., Ltd.): 0.4 mass %

Polyoxyethylene 2-ethylhexyl ether (surfactant, manufactured by AOKI OIL INDUSTRIAL Co., Ltd.): 0.2 mass %

Pure water: 79.995 mass %

The above-listed components are mixed together, and then filtered through a 5-μm filter to obtain Cyan ink 9.

### <Preparation of Cyan Ink 10>

Pigment Blue 15:3 (cyan pigment, manufactured by DIC Corporation): 5.3 mass %

Styrene-methacrylic acid ethyl ester-methacrylic acid salt copolymer (pigment dispersing agent, manufactured by BASF): 0.5 mass %

Propylene glycol (manufactured by Wako Pure Chemical Industries, Ltd., boiling point: 188.2° C.): 13 mass %

1,2-Hexanediol (manufactured by Wako Pure Chemical Industries, Ltd., boiling point: 223° C.): 1.0 mass %

Polyurethane emulsion (solid content: 25%, manufactured by The Nippon Synthetic Chemical Industry Co., Ltd.): 4 mass %

Diimonium compound (infrared absorbing agent, manufactured by Nippon Kayaku Co., Ltd.): 0.005 mass %

OLFINE E1010 (surfactant, manufactured by Nissin Chemical Industry Co., Ltd.): 0.4 mass %

Polyoxyethylene 2-ethylhexyl ether (surfactant, manufactured by AOKI OIL INDUSTRIAL Co., Ltd.): 0.2 mass %

Pure water: 75.595 mass %

The above-listed components are mixed together, and then filtered through a 5-μm filter to obtain Cyan ink 10.

Cyan ink 9 and Cyan ink 10 are each dropped in an amount of 10 mg on a glass plate, and the inks are heated in an open state at 40° C. for 20 minutes. The ink evaporation ratio of Cyan ink 9 is found to be 81.8 mass %. The ink evaporation ratio of Cyan ink 10 is found to be 77.6 mass %.

### <Image Formation>

Cyan ink 9 and Cyan ink 10 prepared above are used to form an image with the following recording apparatus.

A 1 cm×1 cm solid patch at a resolution of 600×600 dpi is printed with Cyan ink 9 ejected as 5-pl droplets by a first head, on OK Topkote+(manufactured by Oji Paper Co., Ltd.) paper, and then irradiated with an IR laser of a wavelength of 940 nm. Similarly, a solid patch is then formed with Cyan ink 10 ejected as 5-pl droplets by a second head, on the pixels formed from Cyan ink 9. The ink is then dried by being irradiated with an IR laser of a wavelength of 940 nm. Thus, a printed image is obtained.

### <Evaluations>

Evaluations are carried out as in Example 1. The evaluation results are described in Table 1 below.

TABLE 1

| | First | Second | Streak | | |
|---|---|---|---|---|---|
| | aqueous | aqueous | uneven- | Image | Clogging |
| | ink | ink | ness | density | resistance |
| Example 1 | Cyan ink 1 | Cyan ink 2 | A | 1.55 | A |
| Example 2 | Magenta | Magenta | A | 1.41 | A |
| | ink 1 | ink 2 | | | |
| Example 3 | Yellow ink | Yellow ink | A | 1.57 | A |
| | 1 | 2 | | | |
| Example 4 | Cyan ink 4 | Cyan ink 5 | B | 1.49 | A |
| Example 5 | Magenta | Magenta | A | 1.38 | B |
| | ink 3 | ink 4 | | | |
| Example 6 | Cyan ink 9 | Cyan ink 10 | A | 1.55 | A |
| Comparative | Cyan ink 3 | — | C | 1.50 | A |
| Example 1 | | | | | |
| Comparative | Cyan ink 6 | — | C | 1.52 | A |
| Example 2 | | | | | |
| Comparative | Cyan ink 7 | Cyan ink 8 | C | 1.56 | A |
| Example 3 | | | | | |

### Example 7

### <Preparation of Black Ink 1>

Carbon black (black pigment, manufactured by Cabot Corporation): 5 mass %

Styrene-acrylic acid salt copolymer (pigment dispersing agent, manufactured by BASF): 0.5 mass %

Propylene glycol (manufactured by Wako Pure Chemical Industries, Ltd., boiling point: 188.2° C.): 8 mass %

1,2-Hexanediol (manufactured by Wako Pure Chemical Industries, Ltd., boiling point: 223° C.): 1 mass %

Polyacrylate emulsion (solid content: 25%, manufactured by The Nippon Synthetic Chemical Industry Co., Ltd.): 4 mass %

OLFINE E1010 (surfactant, manufactured by Nissin Chemical Industry Co., Ltd.): 0.8 mass %

OLFINE E1004 (surfactant, manufactured by Nissin Chemical Industry Co., Ltd.): 0.3 mass %

Pure water: 80.4 mass %

The above-listed components are mixed together, and then filtered through a 5-μm filter to obtain Black ink 1.

### <Preparation of Black Ink 2>

Carbon black (black pigment, manufactured by Cabot Corporation): 5 mass %

Styrene-acrylic acid salt copolymer (pigment dispersing agent, manufactured by BASF): 0.5 mass %

Propylene glycol (manufactured by Wako Pure Chemical Industries, Ltd., boiling point: 188.2° C.): 14 mass %

1,2-Hexanediol (manufactured by Wako Pure Chemical Industries, Ltd., boiling point: 223° C.): 1.0 mass %

Polyacrylate emulsion (solid content: 25%, manufactured by The Nippon Synthetic Chemical Industry Co., Ltd.): 4 mass %

OLFINE E1010 (surfactant, manufactured by Nissin Chemical Industry Co., Ltd.): 0.8 mass %

OLFINE E1004 (surfactant, manufactured by Nissin Chemical Industry Co., Ltd.): 0.3 mass %

Pure water: 74.4 mass %

The above-listed components are mixed together, and then filtered through a 5-μm filter to obtain Black ink 2.

Black ink 1 and Black ink 2 are each dropped in an amount of 10 mg on a glass plate, and the inks are heated in an open state at 40° C. for 20 minutes. The ink evaporation ratio of Black ink 1 is found to be 82.2 mass %. The ink evaporation ratio of Black ink 2 is found to be 76.3 mass %.

### <Image Formation>

An ultrafine color digital standard image N1 defined in JIS standards X9201 is printed with Black inks 1 and 2, Cyan inks 1 and 2, Magenta inks 1 and 2, and Yellow inks 1 and 2 prepared above, with the following recording apparatus.

The inks 1 of the colors are arranged as illustrated in FIGURE. Pixels are printed with the inks 1 ejected as 5-pl droplets by first heads corresponding to the colors, on OK Topkote+(manufactured by Oji Paper Co., Ltd.) paper, and subsequently dried with a small infrared (IR) heater. Similarly, printing is then carried out with the inks 2 of the colors ejected as 5-pl droplets by second heads corresponding to the colors, on the pixels formed from the inks ejected by the first heads of the corresponding colors. The inks are then dried with the IR heater to obtain a printed image.

### <Evaluations>

### —Evaluation for Streak Unevenness—

The printed image obtained in Example 7 is visually evaluated.

A: The whole image has no unevenness and appears to be a good image.

B: The image appears to have slight unevenness, but has no clear streak unevenness.

C: A clear white streak is visually recognized. Example 7 is evaluated as A in terms of streak unevenness.

### —Evaluation for Clogging Resistance—

The evaluation is carried out with the above-described recording apparatus in Example 7: printing is continuously carried out for 1 minute such that a portion of the head is used to print a solid pattern and the other portion is operated for dummy jetting; subsequently, the whole surface of the head is used to print a quarter pattern.

The portion used for printing the solid pattern and the other portion during the continuous printing are compared on the basis of the quarter pattern printed after the continuous printing, and are evaluated on the basis of the following criteria.

A: Printing without any missing dot is carried out from the first dot, and displacement of dots does not occur.

B: Printing without any missing dot is carried out from the first dot, but slight displacement of dots occurs.

C: Displacement of dots by the distance of at least 1 dot and/or missing of dots is observed, and the head is clogged.

Example 7 is evaluated as A in terms of clogging resistance.

Examples in which each pixel is formed with a first aqueous ink and a second aqueous ink having a hue in the same category as in the first aqueous ink and having a lower drying rate than the first aqueous ink, demonstrate suppression of occurrence of streak unevenness in the formed images, compared with Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An aqueous ink set comprising:
a first aqueous ink containing water and a colorant; and
a second aqueous ink containing water and a colorant, having a hue in the same category as in the first aqueous ink, and having a lower drying rate than the first aqueous ink.

2. The aqueous ink set according to claim 1, wherein the second aqueous ink has a higher colorant content than the first aqueous ink.

3. The aqueous ink set according to claim 1, wherein the first aqueous ink has a content of about 80 mass % or more of a solvent containing the water and having a boiling point of less than 150° C., and a content of a solvent containing the water and having a boiling point of less than 150° C. in the second aqueous ink is lower than the content of the solvent containing the water and having a boiling point of less than 150° C. in the first aqueous ink.

4. The aqueous ink set according to claim 2, wherein the first aqueous ink has a content of about 80 mass % or more of a solvent containing the water and having a boiling point of less than 150° C., and a content of a solvent containing the water and having a boiling point of less than 150° C. in the second aqueous ink is lower than the content of the solvent containing the water and having a boiling point of less than 150° C. in the first aqueous ink.

5. The aqueous ink set according to claim 1, wherein a plurality of the first aqueous inks include cyan, magenta, yellow, and black inks, and a plurality of the second aqueous inks include cyan, magenta, yellow, and black inks.

6. The aqueous ink set according to claim 2, wherein a plurality of the first aqueous inks include cyan, magenta, yellow, and black inks, and a plurality of the second aqueous inks include cyan, magenta, yellow, and black inks.

7. The aqueous ink set according to claim 3, wherein a plurality of the first aqueous inks include cyan, magenta, yellow, and black inks, and a plurality of the second aqueous inks include cyan, magenta, yellow, and black inks.

8. The aqueous ink set according to claim 4, wherein a plurality of the first aqueous inks include cyan, magenta, yellow, and black inks, and a plurality of the second aqueous inks include cyan, magenta, yellow, and black inks.

9. An ink cartridge set comprising:
a first ink cartridge containing the first aqueous ink of the ink set according to claim 1; and
a second ink cartridge containing the second aqueous ink of the ink set according to claim 1.

10. An inkjet recording method comprising:
ejecting the first aqueous ink of the aqueous ink set according to claim 1 onto a recording medium; and
ejecting the second aqueous ink of the aqueous ink set onto the ejected first aqueous ink such that at least an ink droplet of the first aqueous ink and an ink droplet of the second aqueous ink form a pixel.

11. The inkjet recording method according to claim 10, further comprising drying the ejected first aqueous ink on the recording medium prior to the formation of the pixel.

12. An inkjet recording apparatus comprising:
the aqueous ink set according to claim 1;
a first ejection head that ejects the first aqueous ink onto a surface of a recording medium; and
a second ejection head that is disposed downstream of the first ejection head in a transport direction of the recording medium, and that ejects the second aqueous ink after the ejection of the first aqueous ink.

13. The inkjet recording apparatus according to claim 12, further comprising a drying unit that is disposed upstream of the second ejection head in the transport direction of the recording medium, and that dries the ejected first aqueous ink.
